(19) United States
(12) Patent Application Publication
(10) Pub. No.: US 2016/0125407 A1
(43) Pub. Date: May 5, 2016

(54) Systems and Methods for Secure Remote Payments

(71) Applicants: Eamon STAFFORD, Kilmore (IE); Larry BREEN, Tramore (IE)

(72) Inventors: Eamon STAFFORD, Kilmore (IE); Larry BREEN, Tramore (IE)

(21) Appl. No.: 14/405,891

(22) PCT Filed: Jun. 5, 2012
(86) PCT No.: PCT/CA2012/050378

§ 371 Date: Jan. 25, 2016

(51) Int. Cl. G06Q 20/40; G06Q 20/32

(52) U.S. Cl. CPC G06Q 20/401; G06Q 20/322; G06Q 2220/00

(57) ABSTRACT

Systems and methods for secure payments are disclosed herein. Authentication of devices with a payment gateway, for making purchases, may occur prior to effecting purchases. Once authentication of the device has occurred with the payment gateway the device user may quickly and easily transact with any vendor in trusted communication with the payment gateway. The device may be altered to allow it to request purchases, as well as to allow vendors, trusted by the payment gateway, to request purchases be made.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Mobile and electronic payments are becoming increasingly important for a variety of industries. However, it is also increasingly difficult secure mobile payments, for example due to regulations, theft, and difficulties for smaller entities, or entities not focused on technology, to implement such payments in a cost-effective way. For example, regulations such as those relating to the Payment Card Industry (PCI) in the United States govern aspects of mobile payments and must be adhered to. In addition, if an entity's core business is not technology, it can be expensive and difficult to implement mobile payments. One particular exemplary type of entity is transit agencies. Although they offer products and services to a broad range of customers, many of whom have mobile devices, they are not typically interested in developing technology but are interested in deploying it for the good of their customers. Of course, they remain sensitive to responsible to regulations and security concerns.

As such there is a need a simple and cost-effective way to enable mobile payments.

### SUMMARY OF THE INVENTION

In one aspect there is a system for secure remote payments comprising a payment gateway configured to communicate, over a first connection type, with a first computing device and payment service operating thereon, and communicate purchase requests, received from a payment service, with a vendor server, and a payment service, operating on the first computing device and configured to receive purchase requests from one or more commerce applications on the computing device, to receive payment service pins from a first user of the first computing device to validate the user with the payment service, and to communicate purchase requests to the payment gateway, over the first connection type, upon receipt of the payment service pin that validates the first user.

The payment gateway may further be configured to communicate a transaction pin, over a second connection type, to the first computing device, in response to receiving a purchase request. The payment service may further be configured to receive the transaction pin from the first user of the first computing device and communicate the transaction pin received from the first user of the first computing device to the payment gateway, over the first connection type, and the payment gateway may communicate the purchase request to the vendor server upon receipt of the transaction pin from the payment service. The payment gateway may have a payment method for the first user stored in a security database, and such payment method may be used to pay for the purchase request. The payment gateway may further be configured to communicate a transaction pin to a second computing device, used by a second user, in response to receiving a purchase request.

The payment service of the first computing device may further be configured to receive the transaction pin and communicate the transaction pin to the payment gateway, over the first connection type and wherein the payment gateway communicates the purchase request to the vendor server upon receipt of the transaction pin from the payment service.

The payment gateway may have a payment method for the second user stored in a security database, and such payment method may be used to pay for the purchase request. The payment service may operate in the background until it receives a purchase request from a commerce application.

The payment service may further comprise a web server that may be invoked by receiving a purchase request from a commerce application. The first connection type may be a UDP connection and a UDP connection may be maintained between the payment gateway and the computing device. Each of the commerce applications may have a separate payment service pin and the payment service may have a security database that stores the payment service pin for each commerce application.

In a further aspect there is a method for effecting a secure electronic payment over a first connection type, the method comprising receiving, by a payment service on a first computing device, a purchase request, from a commerce application on the first computing device, requesting, by the payment service on the first computing device, a payment service pin from a first user of the first computing device, accepting, by the payment service on the computing device, the payment service pin from the first user of the first computing device, submitting, by the payment service on the computing device, the purchase request to a payment gateway over a first connection type, if the payment service pin is approved, and sending, by the payment gateway, the purchase request to the vendor server.

The method may further comprise obtaining, by a payment gateway, the purchase request from the payment service on a computing device, transmitting, by a payment gateway, a transaction pin to the first computing device on a second connection type, requesting, by the payment service on the first computing device, the transaction pin from a first user of the first computing device, accepting, by the payment service on the first computing device, the transaction pin from the first user of the first computing device, providing, by the payment service on the first computing device, the transaction pin that was accepted by the payment service from the first user of the first computing device, to a payment gateway over the first connection type and the submitting may further depend on the transaction pin provided matching the transaction pin transmitted by the payment gateway.

The method may further comprise obtaining, by a payment gateway, the purchase request from the payment service on a computing device, transmitting, by a payment gateway, a transaction pin to a second computing device, requesting, by the payment service on the first computing device, the transaction pin, accepting, by the payment service on the first computing device, the transaction pin, providing, by the payment service on the first computing device, the transaction pin that was accepted by the payment service, to a payment gateway over the first connection type, and the submitting may further depend on the transaction pin provided matching the transaction pin transmitted by the payment gateway.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a diagram of a system for secure payments according to a non-limiting embodiment of the present invention; and

FIG. 2 is a diagram of aspects of a system for secure mobile payments according to a non-limiting embodiment of the present invention;

FIG. 3 is a flowchart depicting a method for registering and activating a system for secure mobile payments according to a non-limiting embodiment of the present invention;

FIG. 4 is a flowchart depicting a method for making a user-driven payment according to a non-limiting embodiment of the present invention;

FIG. 5 is a flowchart depicting a method for making a retailer-driven payment according to a non-limiting embodiment of the present invention; and

FIG. 6 is a diagram of aspects of a system for secure mobile payments according to a non-limiting embodiment of the present invention.

### DETAILED DESCRIPTION OF THE INVENTION

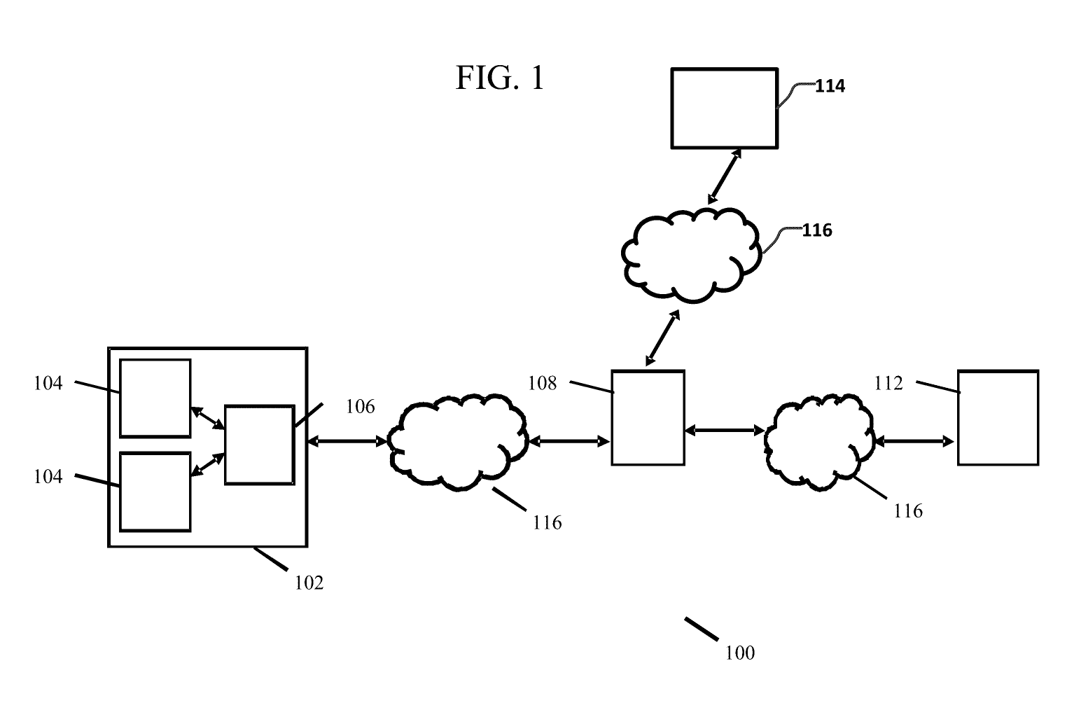

FIG. 1 is a diagram of system 100 for secure payments according to a non-limiting embodiment of the present invention comprising a user computing device (UCD) 102 further comprising UCD applications (UCDA) 104 and UCD payment application (UCDPA) or payment service 106, communications network 116, payment gateway 108, bank 114, and vendor 112.

System 100 allows for secure payments, through implementation of one or more security features. System 100 may provide a secure and fully authenticated approach to process payments, and may use a multi-factor (and/or multi-channel) authentication approach. System 100 may allow for secure authentication of parties (upon registration, activation and during transactions) and prevent many forms of fraudulent activities (man-in-the-middle attacks, phishing, etc). Through these approaches, system 100 assures that the purchaser is who they claim to be, the vendor is who they claim to be, and that no messages are intercepted as transactions are effected.

UCD 102 may be any computing device that users may make payments from, including PCs, mobile devices (cell phones, smart phones, PDAs, tablets and the like), specialized payment devices like key fobs, bank-provided specialized hardware, and the like.

UCD 102 may have one or more user interface elements such as screens, input devices (keyboards, pointing devices, IR ports, NFC capabilities, Bluetooth, buttons, etc).

UCD 102 may further comprise one or more UCDA 104. UCDA 104 may be any type of application on UCD 102 that achieves at least one purpose for a user, such purpose may be, or include, the ability to purchase goods or effect transactions as described herein. UCDA 104 may also be referred to as a commerce application. UCDA 104 may reside on UCD 102—such as applications that are loaded onto memory in UCD 102, like Blackberry™ applications or apps for iPhones™ and iPads™. UCDA 104 may also be accessible by UCD 102 but may not reside thereon—such as websites or web pages (that may be at least partly commerce websites) that are accessible using a browser or other functionality of UCD 102.

UCDPA 106 allows UCD 102 to communicate, in a secure and authenticated way, with payment gateway 108. UCDPA 106 may obviate the need for UCDA 104 to implement significant payment features. UCDPA 106 may perform an initial authentication process, as described herein, to authenticate UCD 102, and its user, to payment gateway 108. After such initial authentication UCDPA 106 may handle a connection to payment gateway 108, such as via communications network 106, to effect a transaction. UCDPA 106 may also be referred to as payment service 106.

UCDPA 106 may be a stub application residing on the handset that invokes authentication through the services operating on payment gateway 108. UCDPA 106 may be an application residing on UCD 102 in an “always on” fashion, acting as a service (such as a background process). UCDPA 106 may be a Java based application operating on Symbian, Android™, Blackberry™ and many CLDC-1.1 compliant JVM's™. Where a JVM is not present it may be run on UCD's 102 specific platform (e.g. iPhone™ Objective-C). Where possible the application may run as a true service (e.g. Android™).

UCDPA 106 may communicate through various transport layers and may employ one or more types of encryption, as described herein.

Bank 114 may be substantially any company that provides methods of payment to users. Bank 114 may be a bank, that offers credit cards, debit cards, prepaid cards and the like, a credit card company such as Visa™, PayPal™, or other such entities. Users of UCD 102 may have one or more accounts with one or more banks 114, such accounts being usable to purchase goods and services from one or more retailers 112. Bank 114 may have systems to accept and authorize payments electronically and may use such systems in communicating with payment gateway 108 via communications network 116. Changes to such systems may not be required.

Retailers or vendors 112 may be any company offering goods or services for sale to users (consumers, businesses, or any other type of purchaser). For example, retailers 112 may be a transit agency that sells transit services, a restaurant, a retail store, a charity, a bank selling banking products, or substantially any such company. Retailers 112 must be capable of executing electronic transactions; retailers 112 that only accept physical cash may not be eligible unless they acquire systems to accept electronic payment, or partner with another company that allows such possibility. Retailers 112 may be the company or entity, or the collection of computer systems, such as servers, that facilitate operations (including receiving payments for goods). Retailers 112 may use computing device (including POS machines and the like), which may be substantially similar to UCD 102, to effect transactions (either accept or initiate) as described herein.

As used herein, goods and services are used substantially interchangeably and are intended to cover anything that a purchaser may purchase, or any situation where a user would be providing compensation (money, etc) to another party. Exemplary goods and services may include transit passes, retails items, professional services (legal, accounting, etc), and charity contributions.

Retailers 112 may have their own websites or webpages that may facilitate a customer viewing products and/or purchasing products. Such websites may be viewable on substantially any UCD 102 possibly requiring some reformatting either by retailers 112 or by browser software on UCD 102 (as known to those of skill in the art). Retailers 112 may alternatively have their own applications for UCDs 102. It is becoming increasingly common, for example, for stores to have mobile applications designed for, and residing on, specific UCDs such as iPhones™. Either of these options may be thought of as being part of UCD 102 or at least partially part of retailers 112 (such as being part of a web server located at retailers 112 that provides content, via communications network 116, to UCD 102 and/or payment gateway 108). Either approach may also be referred to as a commerce application.

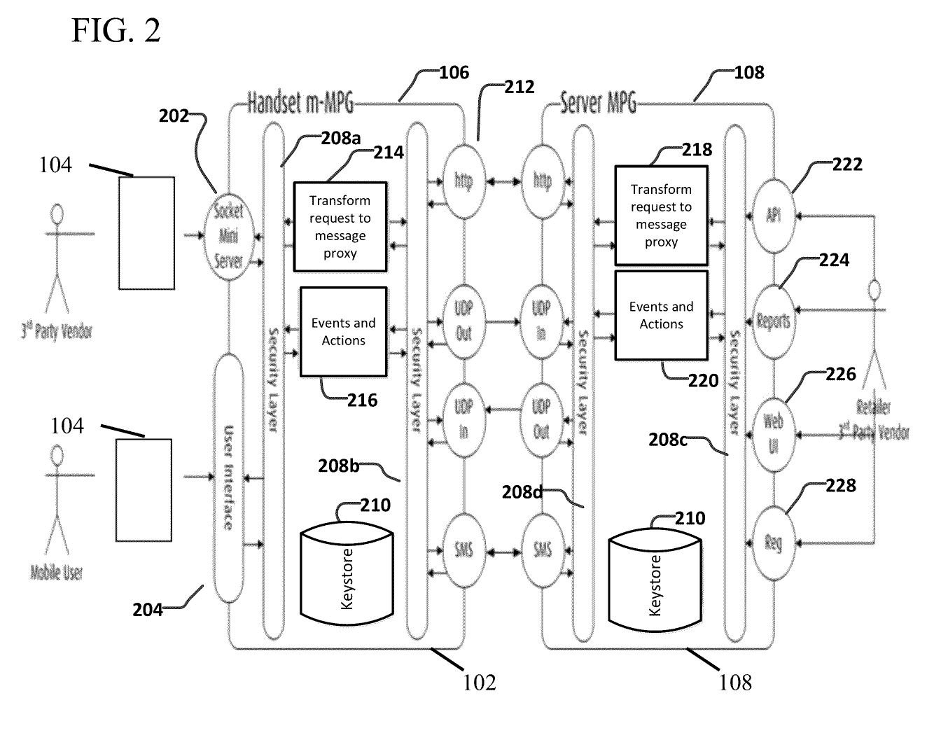

FIG. 2 is a diagram of aspects of system 100 for secure mobile payments according to a non-limiting embodiment of the present invention. FIG. 2 comprises UCD 102 further comprising local server 202, user interface (UI) 204, security layers 208, security database 210, actions module 216, message module 214, and one or more communications channels 212. FIG. 2 further comprises payment gateway 108 further comprising security layers 208, security database 210, actions module 220, message module 218, one or more communications channels 212, API 222, Reports 224, Web UI 226 and registration module 228.

Local server 202 may be a local web server that communicates with 104 when a user is using a web site or web page. Alternatively a user may use user interface 204 to interact with 106. User interface 204 may be a user interface for UCDPA 106, allowing interactions with a user that are required by UCDPA 106 or UCD 102 generally. Although shown to interact with UCDA 104 as an application, user interface 204 may also be used with local server 202—for example where local server serves up pages from user interface 204 to a web browser that is UCDA 104 in a particular embodiment.

Local server 202 may be invoked locally by issuing a standard http call to http://localhost:port or http://127.0.0.1:port (such as by one or more UCDA 104). To invoke UCDPA 106 from UCDA 104 (operating as an application or being a website viewed on UCD 102 browser via, for example, x-Html or WAP) UCDA 104 can issue a http request to local server 202. When activated UCDPA 106 may take over in the foreground, execute the required authentication and return either in http response form or a redirect to the relevant x-Html or WAP page.

Either 202 or 204 me interact with message module 214 via security layer 208a. Security layer 208a may secure or authenticate messages between UCDA 104 and UCDPA 106, security layers 208b/208d may secure or authenticate messages between UCDPA 106 and payment gateway 108, and security layer 208c may secure or authenticate messages between payment gateway 108 and retailers 112 and bank 114 (possibly in conjunction with security layers at retailers 112 and bank 114, not shown). Of course it is to be understood that security layers 208a/b may be implemented together or separately on UCDPA 106 and security lawyers 208c/d may be implemented together or separately on payment gateway 108.

Message module 214 may interact with security database 210 to perform security functions relating to the creation, interpretation, reception and sending of messages, as described herein. By way of example, security layer 208b may receive an encrypted message from payment gateway 108 via http connection 212. Security layer 208b may then access the appropriate encryption key from security database 210 to decrypt the message and provide it to message module 214. As a further example, message module 214 may want to send a message to payment gateway 108. The message may be provided to security layer 208b, which may obtain the appropriate encryption key from security database 210, encrypt the message, and then send it to payment gateway 108 via UDP Out connection 212.

Message module 214 may perform substantially all of the functionality relating to the creation, interpretation, reception and sending of messages from UCDPA 106. Similar modules may exist for UCDA 104 (not shown) and for payment gateway (message module 218). Each message module may create, interpret, receive, and send different messages, and for different purposes, as described herein.

Message module 214 may interact with other modules on UCD 102 to implement functionality. For example, message module 214 may obtain data from users, via user interface 204 for example, that become part of the messages that are sent and received.

Connections 212 allow communication between UCD 102 and payment gateway 108. Various connections, and connection types, are shown in FIG. 2, including http (which also includes https), UDP In and UDP Out, and SMS. Others may be considered as well, such as Bluetooth, NFC, IR, FTP and the like. All of these connections may be implemented over, or using, one or more communications networks 116.

In a preferred embodiment connections 212 include more than one type of connection and are preferably implemented using, or over, different communications networks 116 and/or separate connections 230 on payment gateway 108. This may be preferable to allow multi-channel authentication and security—successful fraudulent activities would require multi-channel interception.

Connections 212 may include a “maintainable” connection, such as a UDP connection, which may allow a connection to be constantly maintained between UCD 102 and payment gateway 108—even when no transaction is occurring. This may help prevent fraudulent activities such as “man in the middle” attacks. It is preferable that there be a “maintainable” connection and ideally that connection is of low bandwidth to maintain and/or not costly to maintain.

UCDPA 106, while executing in the background, may maintain a UDP connection to payment gateway 108, which enables UCDPA 106 to maintain payment gateway's 108 knowledge of that UCD's 102 current IP-Address (or other some form of identifier). UCDPA 106 may also process the messages to and from payment gateway 108 through the message definitions of UCDPA 106 and payment gateway 108.

The UCDPA 106 may be able to communicate over SMS though this method may not be preferred as it represents a costly transport layer and is potentially less reliable. The wireless messaging API functionality provided by all MID-2.0 (MID-.0 with WMA JSR) may be utilised outside of Android and iPhone.

UCDPA 106 may be activated through various push technologies including all standard application push activation mechansisms. The application will register itself to enable push activation on http ports, sms ports, various alarms, and a timed invocation. The timed invokcation is primarlity included to ensure the application will restart itself for whatever failure reason occurs (e.g. handset reboot, or user killing the process on the handset). Various other third-party push technologies may also be employed.

The UCDPA 106 may be invoked or brought to the foreground either locally or remotely in various ways. UCDA 104, running locally on UCD 102, may invoke UCDPA 106, for example by referencing 127.0.0.1:port through a http post. UCDA 104, operating as a mobile web application, may invoke the UCDPA 106 via a call to the 127.0.0.1:port and pass various paramaters to redirect on completion and maintain headers and values to pass back to the redirect response. After the UCDPA 106 has completed its requested tasks it may force itself back into the background.

Descriptions of one message module 214/218 or one security layer 208a/b/c/d are intended to be relevant to other message modules, unless particular specificity is described (for example in saying that “only” a particular module would perform a specific task, or operate in a particular way).

It is to be understood that although several modules and databases are shown, they may be implemented together, or further separated, and remain within the scope of the present invention.

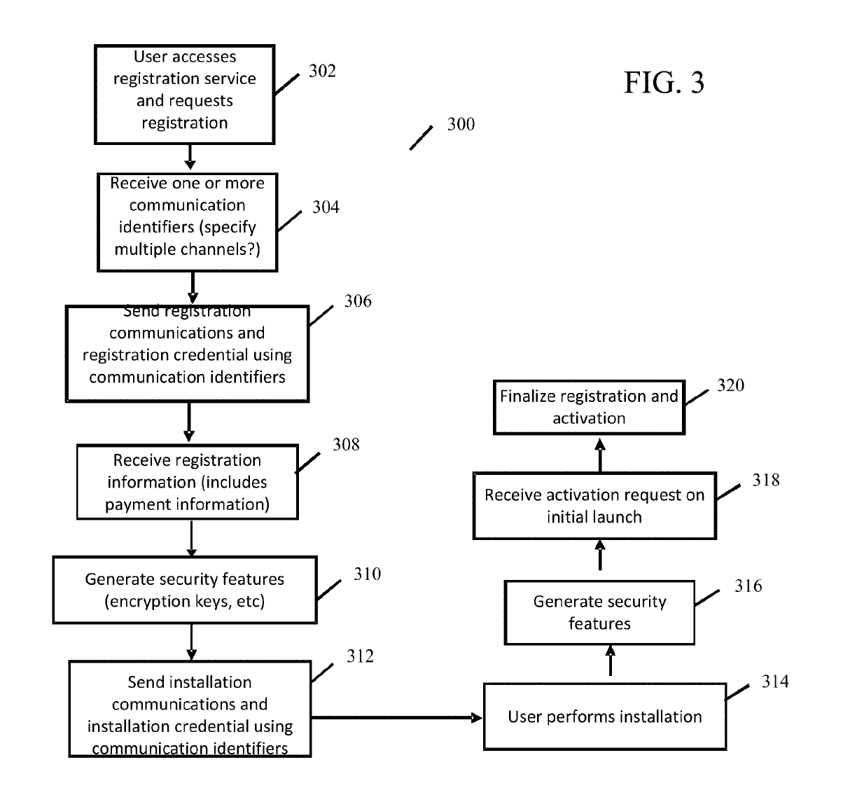

FIG. 3 is a flowchart depicting method 300 for registering and activating a system for secure mobile payments according to a non-limiting embodiment of the present invention.

Method 300 begins at 302 where a user accesses the registration service and requests registration. Such access may be using UCD 102. Although several ways to access are considered, two of those include by navigating to a registration website using a web browser, and sending an SMS message to a short number or short code and receiving a link to a web page to visit using a mobile device implementation of UCD 102.

At 304 one or more communication identifiers are received, for example by payment gateway 108, from the user, such as an email and mobile phone number. At 306 registration communications and registration credentials are sent to the provided communication identifiers. This may be in the form of an email and SMS, where the email contains a link to download software (such as to installation software for UCDPA 106 for UCD 102), and the SMS contains an activation key or token. Of course other combinations of communication methods and identifiers may be used; the goal being multi-channel registration.

At 308 a user provides the rest of their information to payment gateway 108 to establish their profile. This may include name and address information, payment methods (which may include providing credit cards numbers, CV codes, Visa Verified™ information, and the like), UCD 102 type (such as Windows™ or Mac™ computers or Blackberry smartphones), etc.

At 310 various security features are established. This may include PIN codes for payment methods, encryption keys for encrypting between payment gateway 108 and UCD 102 (such as public/private keys). Upon generation, these security features may be stored in security database 210 (on one or more of payment gateway 108 and UCD 102) and organized according to the user, or commerce application, for example.

At 312 a link to the software is provided, or another form of providing the software is undertaken (such as over the air downloading). This enables establishment of UCDPA 106 on UCD 102.

At 314 UCDPA 106 is installed on UCD 102. This may involve setting various parameters, as is known to those of skill in the art.

At 316 security features may again be established. Although this may be similar to 310, at 316 UCDPA 106 has been installed and security database 210 has been established on UCD 102. This may allow further security features and keys to be generated or exchanged between UCD 102 and payment gateway 108.

At 318 an activation request is received upon initial launch of UCDPA 106. At this stage, further information may be required from a user to initially authenticate them, and their UCD 102, to payment gateway 108. This may involve exchanging various information about the user (such as pin codes or further activation codes) and/or information about UCD 102 (such as hardware identifiers like IMEI numbers, SIM card numbers, etc).

At 320 activation is finalized to make a user (with their UCD 102) registered, activated and ready to perform a transaction.

At the end of method 300, UCD 102 has been positively activated and importantly authenticated by payment gateway 108.

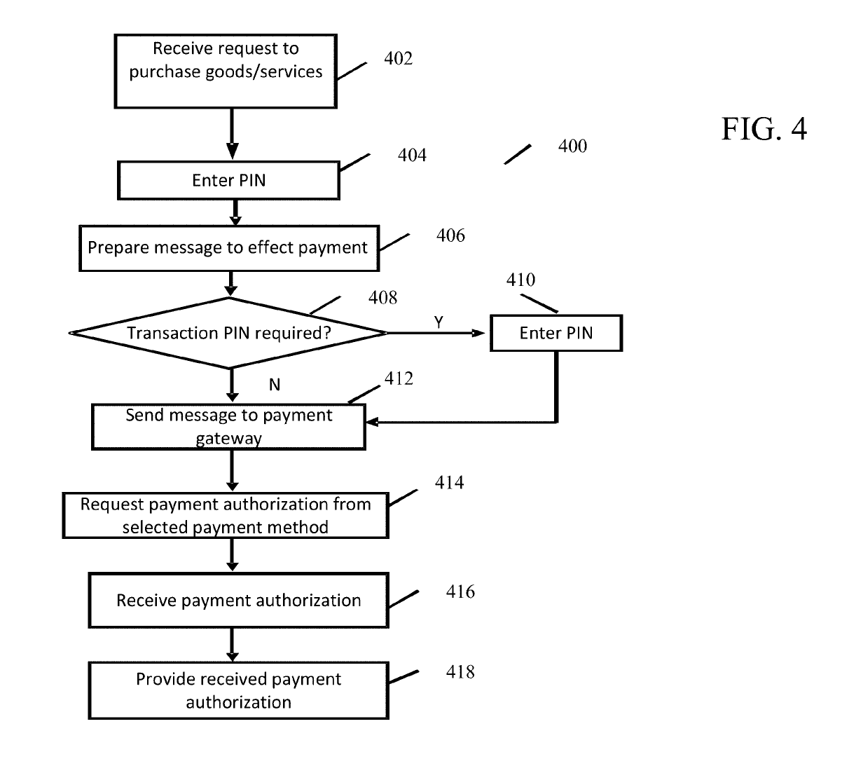

FIG. 4 is a flowchart depicting a method for making a user-driven payment according to a non-limiting embodiment of the present invention. Before describing the method depicted in FIG. 4, an overview of transactions should be provided.

After method 300 is completed, a particular UCD 102 may be in a state of waiting for transactions involving that UCD 102 to occur. As described herein, UCD 102 may maintain a connection to payment gateway 108 (for example via UDP connection 212), however UCD 102 is essentially waiting.

UCD 102 may be brought out of a “waiting” state by a user of UCD 102 initiating a transaction requiring UCDPA 106. This may be, for example, by user of UCD 102 wanting to buy a bus ticket using UCDA 104 on UCD 102. Such a transaction is described herein as a “user-driven payment”, is largely described with respect to method 400, and is an exemplary purchase request. Alternatively, UCD 102 may be brought out of a “waiting” state by retailer 112 initiating a transaction requiring UCDPA 106. This may be, for example. Such a transaction is described herein as a “retailer-driven payment”, is largely described with respect to method 500 and is a further exemplary purchase request.

Turning to method 400, a request is received to purchase goods at 402. Throughout the description of method 400 reference will be made to an example of a user purchasing a shirt from an online store operated by a company called ShirtCo (believed to be fictional), using their Visa card.

As described herein, a request at 402 is initiated by UCD 102 operated by the user who is purchasing the goods. A request at 402 may be considered to be made at the point where UCDPA 106 is first contacted by UCDA 104 and brought out of “waiting”. The user may be navigating through ShirtCo's website or ShirtCo's mobile phone app. They select a shirt to purchase and select “Buy”, causing a request to be made.

UCDPA 106 is then activated, either having its user interface 204 displayed on UCD 102 or activating its local server 202.

A pin, which may be referred to as a payment service pin, is then entered at 404. The pin may be entered by the purchaser using UCD 102 and entering the pin in user interface 204 (or UCDA's 104 user interface, for example if UCDPA 106 is invoked via its local server 202). The pin may identify the user to UCDPA 106 and/or payment gateway 108, for example allowing UCDPA to access security database 210 and/or continue the transaction. This may prevent an authorized user of UCD 102 from making a purchase. If the payment service pin provided is not known, recognized or approved by UCDPA 106 the transaction may be cancelled. The payment service pin itself may be stored in security database 210.

At 406 the message is prepared to effect payment. This may be done by message module 214 and may involve security module 208 accessing security database 210 to obtain the proper encryption key to encrypt the message for transmission to payment gateway 108. Messaging module 214 may also format the message to effect payment (such as identifying the shirt, SKU, selected payment method, and other details that may not already be stored in payment gateway 108 from the user's registration process).

It is worth noting that information regarding the selected payment method need not be communicated by UCD 102 to payment gateway 108. Customarily this would be the case however this information may preferably have been provided by UCD 102 during registration. This may be the case even if retailer 112 was not previously connected with UCD 102. Providing retailer 112 has a relationship with payment gateway 108 (or establishes one) retailer 112 can accept secured payments from the particular UCD 102. This trusted relationship between payment gateway 108 and UCD 102 (either the specific hardware, the user of UCD 102, or a combination thereof), enables quicker deployment and growth of secure payment systems for both consumers and retailers, and reduces the transmission of sensitive data that may be stolen for fraudulent purposes. For example, this relationship may obviate the need for PCI compliance, testing of such, or portions thereof.

At 408 a determination is made whether a transaction pin is required for the particular transaction. This may be based on, for example, characteristics of the transaction (amount, number of items, type of item, country of vendor, etc), characteristics of the payment method selected (credit cards may require their own pins, PayPal passwords or numbers, or simply pins determined by one or more of payment gateway 108, bank 114 or retailer 112). In our example, a Visa Verified™ number may be required.

If a pin is required, it is entered at 410, for example using one or more user input elements of UCD 102. Assuming the proper pin is input then method 400 continues to 412. If a pin is not required at 408 method 400 continues directly to 412.

The pin that may be required at 410 may be provided to the user in real-time or may be dynamically known. It may also be delivered via a separate UCD 102, or via a separate connection 212 from the rest of the communication and/or the other pin. For example, if UCD 102 is a personal computer and the transaction is occurring over HTTPS, for example, payment gateway 108 may send the pin, required at 410, to a user's mobile phone via SMS. They may then type in the pin into the browser on their UCD 102 (personal computer) effecting the transaction. As such there is a further authentication that the user purchasing the good with their personal computer is the proper user. Such pin may also be provided to a separate computing device, from the one initiating the purchase request, for example if a bus driver initiates the transaction (on behalf of the rider, and requesting that the rider's account be reduced) on their on-board or mobile computing device, and the rider's computing device (mobile phone for example) is provided the transaction pin for confirmation that they want their account reduced. The rider can then provide the driver the required transaction pin.

It is to be understood that the pin at 404 may be compared to a pin stored locally on UCD 102. The pin at 410 may be stored locally on UCD 102 or may be sent by one or more of payment gateway 108, bank 114 or retailer 112 (and provided to UCD 102 via payment gateway 108). For example, this pin, or any other pins, may be sent via a second channel (such as in an email or SMS) which may require the user to have access to that channel, thus helping prevent fraud by impersonation or stolen UCDs 102.

At 412 a message is sent from UCD 102 to payment gateway 108. The message may be sent over any one or more of connections 212 and will include enough information to effect the transaction. The message may also be encrypted.

Payment gateway 108 then requests payment authorization from bank 114, based on the method of payment selected by the user, at 414. In the present example, that would be Visa (or whatever bank 114 issued the Visa card).

At 416 payment gateway 108 receives authorization from bank 114. This may be an acknowledgement, for example, that suitable credit exists on a credit card and the user has been making their payments.

At 418 the authorization is returned to UCD 102 to indicate success, and a message is provided to retailer 112 to fulfill an order, and providing the financial details of the transaction.

It is to be understood that issues of availability of stock, discounting, returns, and other normal aspects of electronic payments will still be available using the present system, as would be known to those of skill in the art.

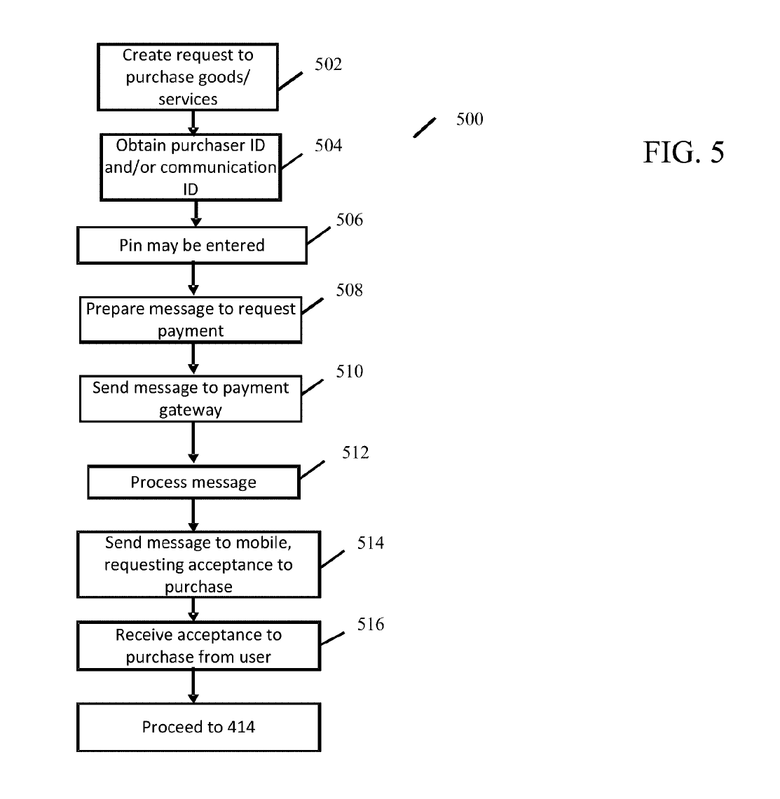

FIG. 5 is a flowchart depicting a method 500 for making a retailer-driven payment according to a non-limiting embodiment of the present invention.

Method 500 begins at 502 where a request to purchase goods is created (a purchase request). At 502 this request is made by a retailer, as such term is described herein. This request may be, for example, a retail payment for the purchase of a shirt, or the purchase of a ticket (such as a bus or train ticket) where the transit agency may be the retailer. In such cases, the retailer may proactively create the request—the customer has provided the shirt to the cashier who has scanned it and now seeks payment or a bus driver who has pulled up to a stop and people are getting on to ride the bus and the driver needs them to pay for the service. Creating the request may be made, for example, by any computing device used by a retailer. These may include debit and credit card terminals, bus fare collectors, mobile phones, and the like.

Once the creation is started, method 500 continues to 504. At 504 the retailer obtains the purchaser's ID and or communication ID. Essentially at 504 the retailer needs to be able to communicate the created payment request to the intended purchaser. In one embodiment, a user may tell retailer 112 their mobile phone number (UCD 102) that they are carrying with them and which has an active UCDPA 106 operating thereon.

At 506 retailer 112 (or its agent) may enter a PIN to assure retailer 112 that the transaction should be transmitted to UCD 102, and to provide an auditable trail. This may also be performed using existing retail POS systems, which may be configured to provide such data.

At 508 the message is prepared. This may involve, for example, encrypting the information or assembling all the required information to uniquely create and identify the transaction.

At 510 the message is sent to payment gateway 108. This may be via any connection 212, API 222 or web UI 226, over communications network 116.

At 512 payment gateway processes 108 the message to interpret and prepare to send it to UCD 102.

At 514 the message is sent to UCD 102 from payment gateway 108. When UCD 102 receives the message, via UCDPA 106, UCDPA 106 is brought to the foreground so the user can accept the payment at 516. Such acceptance may be, for example, by selecting and “accept” button, or providing a PIN, for example.

Method 500 may then proceed to 414 in method 400, to complete the transaction, substantially similarly to embodiments described with respect to method 400.

It is to be understood that several variations to methods 400 and 500 are contemplated within the scope of embodiments of the present invention. For example, 504 may be accomplished via communication directly between UCD 102 and retailer's 112 system. This may involve, for example, NFC communication. UCD 102 may directly communicate with retailer 112, providing acceptance and other data to allow a transaction to complete, and then retailer 112 may communicate with payment gateway 108.

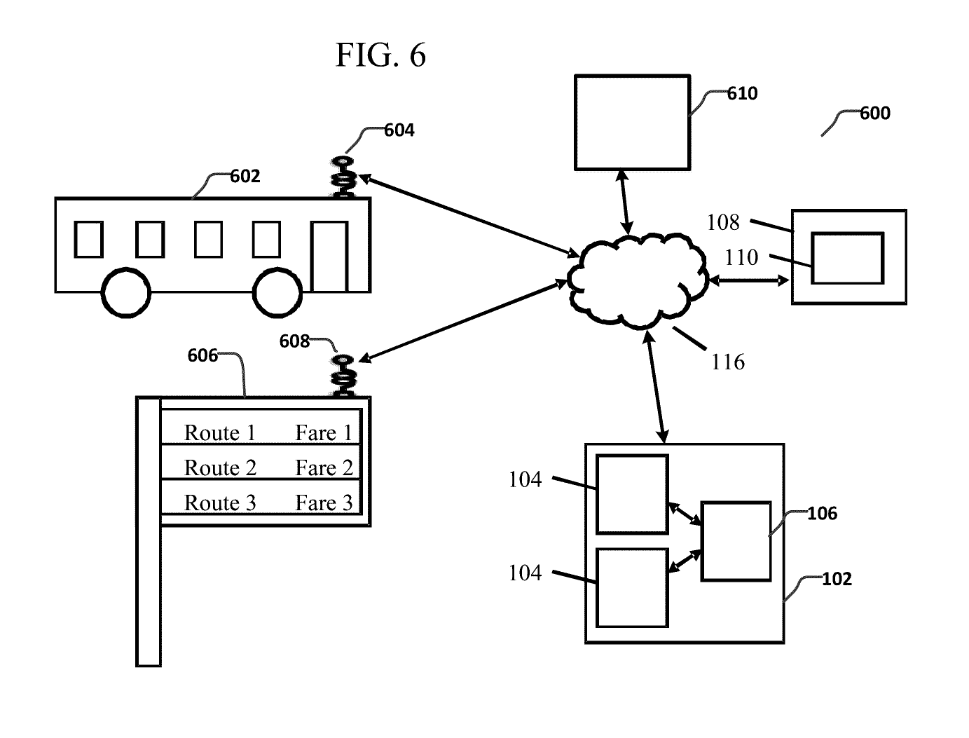

FIG. 6 is a diagram of aspects of a system 600 for secure mobile payments according to a non-limiting embodiment of the present invention.

System 600 further comprises vehicle 602 further comprising vehicle communication device 604, and sign 606, further comprising sign communication device 608, and transit agency 610.

Vehicle 602 may be substantially any vehicle that provides a good or service in exchange for payment. Vehicle 602 may include buses, planes, taxis, vehicles that sell food goods, and the like. Vehicle communication device 604 may be any device, or devices, that allow electronic communication of information from and to vehicle 602. Such communication may allow vehicle 602 to communicate over communications network 116, in any of the approaches as described herein or known in the art, with any other aspects of system 600 or system 100.

Sign 606 may be any sign that displays information about goods or services that can be purchased, and may be connected to or affiliated with one or more vehicles 602. For example, sign 606 may be a sign that displays bus routes that stop at the sign, when vehicles on that route are expected to be at the stop, and how much the fare costs for each vehicle. Sign communication device may be substantially similar to vehicle communication device 604, except that it works with sign 606.

Transit agency 610 may be any entity that owns or operates one or more vehicles to provide transportation services. Transit agencies often have several systems for scheduling, route monitoring, maintenance, payment processing, and the like. Transit agency 610 may be connected to one or more communication networks to facilitate communication with other parties involved in providing transportation and vehicles in their fleet.

Several embodiments of, or uses for, system 600 are contemplated:
(a) A user, with UCD 102, is at wayside sign 606, waiting for a bus to arrive. Through interaction with sign 606 (via sign communication device 608), a user purchases a ticket for their desired route via UCDPA 106. This may involve UCDA 104, belonging to the transit agency providing service on the route, being provided information (identifying the available routes/fares at the stop the user is at) from sign 606. That information is then presented to user of UCD 102, who may then follow the methods described herein to purchase their desired ticket.
(b) A user, with UCD 102, boards vehicle 602. Through interaction with on-board systems (not shown), a user requests (or is asked) to pay for their use. This may be accomplished using UCDA 104 or a UCD 102 belonging to the vehicle operator and/or UCDPA 106, as described herein.
(c) Transit agency 610 may have one or more user accounts for clients that have registered as users of the transportation services being provided. Such clients may be paratransit clients or regular fixed route clients, for example. In the above examples, a user with UCD 102 may be prompted by UCDA 104 whether they are a registered user. If they are, they may choose to use the credit or balance in their account with transit agency 610 to purchase their ticket. If they are not a registered user they may be asked to register and/or they may continue to pay their fare based on approaches described herein using UCDPA 106. Alternatively UCDPA 106 may be set up on UCD 102 with the user's account information at transit agency 610. As such they may more tightly leverage the security features of aspects of the present invention.

With any of the above embodiments, multiple computing devices may be used, as described herein, to ensure that only authorized users are initiating purchase requests (such as via payment service pins), and all user paying for such purchases are authorizing such purchases (such as via transaction pins).

It will be apparent to one of skill in the art that other configurations, hardware etc may be used in any of the foregoing embodiments of the products, methods, and systems of this invention. It will be understood that the specification is illustrative of the present invention and that other embodiments within the spirit and scope of the invention will suggest themselves to those skilled in the art. All references cited herein are incorporated by reference.

What is claimed is:

1. A system for secure remote payments comprising:
a payment gateway configured to communicate, over a first connection type, with a first computing device and payment service operating thereon, and communicate purchase requests, received from a payment service, with a vendor server; and
a payment service, operating on the first computing device and configured to receive purchase requests from one or more commerce applications on the computing device, to receive payment service pins from a first user of the first computing device to validate the user with the payment service, and to communicate purchase requests to the payment gateway, over the first connection type, upon receipt of the payment service pin that validates the first user.

2. The system of claim 1 wherein the payment gateway is further configured to communicate a transaction pin, over a second connection type, to the first computing device, in response to receiving a purchase request.

3. The system of claim 2 wherein the payment service is further configured to receive the transaction pin from the first user of the first computing device and communicate the transaction pin received from the first user of the first computing device to the payment gateway, over the first connection type, and wherein the payment gateway communicates the purchase request to the vendor server upon receipt of the transaction pin from the payment service.

4. The system of claim 3 wherein the payment gateway has a payment method for the first user stored in a security database, and such payment method is used to pay for the purchase request.

5. The system of claim 1 wherein the payment gateway is further configured to communicate a transaction pin to a second computing device, used by a second user, in response to receiving a purchase request.

6. The system of claim 5 wherein the payment service of the first computing device is further configured to receive the transaction pin and communicate the transaction pin to the payment gateway, over the first connection type and wherein the payment gateway communicates the purchase request to the vendor server upon receipt of the transaction pin from the payment service.

7. The system of claim 6 wherein the payment gateway has a payment method for the second user stored in a security database, and such payment method is used to pay for the purchase request.

8. The system of claim 1 wherein the payment service operates in the background until it receives a purchase request from a commerce application.

9. The system of claim 8 where the payment service further comprises a web server that may be invoked by receiving a purchase request from a commerce application.

10. The system of claim 1 wherein the first connection type is a UDP connection and a UDP connection is maintained between the payment gateway and the computing device.

11. The system of claim 1 wherein each of the commerce applications has a separate payment service pin.

12. The system of claim 11 wherein the payment service has a security database that stores the payment service pin for each commerce application.

13. A method for effecting a secure electronic payment over a first connection type, the method comprising:
receiving, by a payment service on a first computing device, a purchase request, from a commerce application on the first computing device;
requesting, by the payment service on the first computing device, a payment service pin from a first user of the first computing device;
accepting, by the payment service on the computing device, the payment service pin from the first user of the first computing device;
submitting, by the payment service on the computing device, the purchase request to a payment gateway over a first connection type, if the payment service pin is approved; and
sending, by the payment gateway, the purchase request to the vendor server.

14. The method of claim 13 further comprising:
obtaining, by a payment gateway, the purchase request from the payment service on a computing device;
transmitting, by a payment gateway, a transaction pin to the first computing device on a second connection type;
requesting, by the payment service on the first computing device, the transaction pin from a first user of the first computing device;
accepting, by the payment service on the first computing device, the transaction pin from the first user of the first computing device;
providing, by the payment service on the first computing device, the transaction pin that was accepted by the payment service from the first user of the first computing device, to a payment gateway over the first connection type; and
wherein the submitting further depends on the transaction pin provided matching the transaction pin transmitted by the payment gateway.

15. The method of claim 13 further comprising:
obtaining, by a payment gateway, the purchase request from the payment service on a computing device;
transmitting, by a payment gateway, a transaction pin to a second computing device;
requesting, by the payment service on the first computing device, the transaction pin;
accepting, by the payment service on the first computing device, the transaction pin;
providing, by the payment service on the first computing device, the transaction pin that was accepted by the payment service, to a payment gateway over the first connection type; and
wherein the submitting further depends on the transaction pin provided matching the transaction pin transmitted by the payment gateway.
